(19) United States
(12) Patent Application Publication
(10) Pub. No.: US 2023/0148293 A1
(43) Pub. Date: May 11, 2023

(54) SEALING INSERT FOR A CORRUGATED-PIPE SCREW FASTENING SYSTEM, CORRUGATED-PIPE SCREW FASTENING SYSTEM, AND METHOD FOR FITTING A CORRUGATED PIPE

(71) Applicant: PFLITSCH GMBH & CO. KG, Hückeswagen Nordrhein Westfalen (DE)

(72) Inventors: Roland LENZING, Hückeswagen (DE); Martin LECHNER, Lindlar Nordrhein-Westfalen (DE); Rosario LI PIRA, Wipperfürth (DE)

(73) Assignee: PFLITSCH GMBH & CO. KG, Hückeswagen Nordrhein Westfalen (DE)

(21) Appl. No.: 18/096,806

(22) Filed: Jan. 13, 2023

Related U.S. Application Data
(63) Continuation of application No. PCT/EP2021/069743, filed on Jul. 15, 2021.

(30) Foreign Application Priority Data
Jul. 17, 2020 (DE) 10 2020 118 953.2

(51) Int. Cl. F16L 25/00

(52) U.S. Cl. CPC F16L 25/0054

(57) ABSTRACT

A sealing insert for a corrugated-pipe screw fastening system includes a cutout for receiving a corrugated pipe, first and second end faces, a first external wall portion having a first outer diameter, and a second external wall portion having a second external diameter. An internal wall delimiting the cutout includes at least one partially circumferentially extending rib. The first external wall portion is adjacent to the first end face and extends along a longitudinal axis of the sealing insert up to the second external wall portion. The second external wall portion is adjacent to the second end face and extends along the longitudinal axis up to the first external wall portion. The first outer diameter is larger than the second outer diameter. An anti-rotation structure is arranged on an outer shell of the sealing insert. The anti-rotation structure is associated with the second external wall portion.

### CROSS-REFERENCE TO RELATED APPLICATIONS

This application is a continuation of International Application No. PCT/EP2021/069743, filed on Jul. 15, 2021, which claims priority to and the benefit of German Application No. 10 2020 118 953.2 filed on Jul. 17, 2020. The disclosures of the above applications are incorporated herein by reference.

### FIELD

The present disclosure relates to a sealing insert for a corrugated-pipe screw fastening system, a corrugated-pipe screw fastening system, and a method for fitting a corrugated pipe.

### BACKGROUND

The statements in this section merely provide background information related to the present disclosure and may not constitute prior art.

Fittings for corrugated pipes are known from the prior art, for example a cable protection system comprising corrugated pipes and fittings for the corrugated pipes, which are attachable to a connection geometry. The fittings known from the prior art are not tight per se; rather, additional seals must be introduced to ensure tightness against the ingress of liquids. To ensure special sealing requirements, it is furthermore necessary to provide a cable screw fastening system downstream of the fitting, which makes the structure very large.

US 2005/0023832 A1 discloses a corrugated pipe fitting for sealed termination of a corrugated pipe. The fitting comprises a tubular fitting body, a sleeve-shaped retainer and a coupling nut. The fitting body has a sleeve with a receiving hole for the corrugated tube and an external thread. The retainer has a through hole with two circumferential ribs for engaging with the corrugations of the corrugated pipe. The coupling nut has an internal thread that engages with the external thread. The retainer has a short pipe section and an outwardly projecting flange at one end. The pipe section has a circular-cylindrical outer contour with an outer diameter that is uniform along its length, and the receiving hole of the sleeve has a circular-cylindrical inner contour with an inner diameter that is equal to the outer diameter. The retainer is seated with the pipe section in the receiving hole of the sleeve. The flange is adjacent to a first end face of the retainer and extends along a longitudinal axis of the retainer up to the short pipe section, and the short pipe section is adjacent to a second end face of the retainer and extends along the longitudinal axis to the flange.

GB 2 178 125 A discloses a coupling for a corrugated pipe. The coupling includes a tubular main body, a sleeve and a coupling nut. The main body has a sleeve with a receiving hole for the corrugated pipe and an external thread. The sleeve has a through hole with a plurality of circumferential ribs for engaging with the corrugation of the corrugated pipe. The coupling nut has an internal thread that engages with the external thread. The sleeve comprises a single external wall portion that is adjacent to both a first end face and a second end face of the sleeve and extends along a longitudinal axis of the sleeve from the first end face to the second end face. The single external wall portion has a uniform hexagonal external contour over its entire length, and the receiving hole of the sleeve has a hexagonal internal contour corresponding to the hexagonal external contour so that the sleeve is slidably but non-rotatably seated in the receiving hole of the sleeve.

US 2015/0316187 A1 discloses a coupling for a corrugated pipe. The coupling includes a tubular socket, a sleeve and a coupling nut. The socket has a collar with a receiving hole for the corrugated pipe and an external thread. The sleeve has a through hole with several circumferential ribs for engagement with the corrugations of the corrugated pipe. The coupling nut has an internal thread that engages with the external thread. The sleeve has a short pipe section and an outwardly projecting flange at one end. The pipe section has a circular cylindrical outer contour with an outer diameter that is uniform along its length, and the receiving hole of the sleeve has a circular cylindrical inner contour with an inner diameter that is equal to the outer diameter. The sleeve is seated with the pipe section in the receiving hole of the collar. The flange is adjacent to a first end face of the sleeve and extends along a longitudinal axis of the sleeve up to the short pipe section, and the short pipe section is adjacent to a second end face of the sleeve and extends along the longitudinal axis to the flange.

### SUMMARY

This section provides a general summary of the disclosure and is not a comprehensive disclosure of its full scope or all of its features.

The present disclosure improves the fittings known from the prior art. In particular, the present disclosure provides a compact fitting or a system with which a corrugated pipe can be tightly attached to a connection geometry.

The present disclosure provides a sealing insert for a corrugated-pipe screw fastening system comprising a cutout for receiving a corrugated pipe, a first and a second end face, a first external wall portion having a first outer diameter, and a second external wall portion having a second outer diameter. An internal wall of the sealing insert delimiting the cutout comprises at least one, and in some forms a plurality of, and in some forms at least two, partially circumferentially extending ribs. The first external wall portion is adjacent to the first end face and extends along a longitudinal axis of the sealing insert up to the second external wall portion. The second external wall portion is adjacent to the second end face and extends along the longitudinal axis up to the first external wall portion. The first outer diameter is larger than the second outer diameter. The first and second external wall portions are each configured to be cylindrical. An anti-rotation structure is arranged on an outer shell of the sealing insert. The anti-rotation structure is associated with the second external wall portion.

Furthermore, the present disclosure provides a corrugated-pipe screw connection system at least comprising a pressing screw, a screw fastening body and a sealing insert according to the present disclosure.

Furthermore, the present disclosure provides a use of a sealing insert in a corrugated-pipe screw fastening system for sealing a corrugated pipe with respect to a screw fastening body of the corrugated-pipe screw fastening system and for inhibiting the sealing insert and/or the corrugated pipe from rotating in a screw fastening body.

Furthermore, the present disclosure provides a use of a corrugated-pipe screw fastening system for connecting a corrugated pipe to a connection geometry.

Furthermore, the present disclosure provides a method for fitting a corrugated pipe with a plurality of corrugation troughs to a connection geometry. The method includes threading a pressing screw onto the corrugated pipe; inserting the corrugated pipe in the cutout of a sealing insert in such a manner that at least one rib, in some forms a plurality of ribs, and in one form at least two ribs, are in engagement with a corrugation trough, if at least two ribs are provided, they are in engagement with two corrugation troughs, generally, if there is a predetermined number of ribs, these ribs are in engagement with a number of corrugation troughs of the corrugated pipe corresponding to this number of ribs; inserting a screw fastening body into the connection geometry; inserting the sealing insert with the corrugated pipe into the screw fastening body, wherein the anti-rotation structure of the sealing insert is brought in engagement with an anti-rotation structure of the screw fastening body and the sealing insert with the first external wall portion protrudes from the screw fastening body; and screwing the pressing screw onto the screw fastening body in such a manner that a material displacement of a material of the sealing insert is produced by the pressing screw. The material rests at least partially sealingly against the corrugated pipe.

In one form, a sealing insert for a corrugated-pipe screw fastening system is disclosed that comprises a cutout, in particular a cutout passing completely through the sealing insert, formed in the direction of a longitudinal axis of the sealing insert, for receiving a corrugated pipe, wherein an anti-rotation structure is arranged on an outer shell of the sealing insert. An internal wall delimiting the cutout comprises at least one, in some forms a plurality of, and in one form at least two, at least partially circumferentially extending ribs.

A corrugated pipe in the meaning of the present disclosure is a pipe made of a material such as, for example, a plastic or a metal, with a diameter that, at least in a partial region or a partial length of the pipe, in one form over a total length of the pipe, changes in a corrugated manner in a longitudinal direction of the pipe, in particular an outer diameter that changes in a corrugated manner in a longitudinal direction, in one form also an inner diameter that changes in a corrugated manner in a longitudinal direction, in another form an outer diameter and an inner diameter whose corrugations correspond in terms of their corrugation troughs and corrugation crests. Because of the corrugation due to the formation of corrugations, at least on an outer surface of the pipe, in one form also on an inner surface of the pipe, the corrugated pipe is flexible. In one form, the corrugations are diameter changes formed in a ring-like manner in the longitudinal direction. The at least two corrugations form a corrugation crest and a corrugation trough between two corrugation crests. The corrugations can be configured to be continuous or discrete. For example, continuously configured corrugations are substantially sinusoidal in a longitudinal section of the corrugated pipe. In an exemplary configuration of the corrugated pipe with a discrete course of the corrugations, in particular between two corrugation crests, these corrugations have a flat portion forming a corrugation trough on the outer surface of the corrugated pipe. In cross-section, the corrugation crests can be configured to be approximately or exactly sinusoidal, rectangular, trapezoidal, semicircular or partially oval. In connection with the corrugated pipe, a screw fastening system with an insert can be provided or arranged, which engages around cables or hoses guided in the corrugated pipe, so that they are given stability in the screw fastening system and, advantageously, a certain sealing effect can also be achieved by the insert.

Insofar as the term “substantially” is used in the present disclosure, this indicates a tolerance range which is justifiable for the person skilled in the art from an economic and technical point of view, so that the corresponding feature can still be recognized or implemented as such.

In one configuration, it is provided that the sealing insert is substantially cylindrical in shape. In another configuration, it is provided that the sealing insert has a first end face and an opposite second end face. In one form, the sealing insert comprises an outer shell, in one form having at least in part the configuration of a cylindrical shell. In another form, the sealing insert comprises a cutout formed to pass completely through the sealing insert.

In the meaning of the present disclosure, “to pass completely through” means that the cutout extends completely from a first end face to a second end face in a longitudinal direction defined along a longitudinal axis of the sealing insert. This also defines a length of the sealing insert and thus of the internal wall thereof. In one form, the cutout is configured to receive a corrugated pipe.

In one configuration, the cutout comprises a delimiting internal wall. The internal wall delimiting the cutout can be configured to be at least partially cylindrical and/or at least partially conical.

In another configuration, the cutout completely passing through is delimited by an internal wall. The internal wall has a first internal wall portion. In one form, it is provided that the first internal wall portion is associated with the first end face of the sealing insert. In another form, it is provided that the first internal wall portion is associated with the second end face of the sealing insert. In one form, the first internal wall portion comprises at least one, in one form a plurality of, partially circumferentially extending ribs. In particular, the ribs are configured such that they extend in a radially inward direction, in one form into a cavity formed by the cutout. The ribs are, in one form, formed to be completely circumferentially extending. In the meaning of the present disclosure, the term “circumferential” is to be understood as meaning that a longitudinal extent of a rib extends along a circumference of the internal wall. A longitudinal extent of a rib extends perpendicular to the longitudinal axis of the sealing insert. A completely circumferentially extending rib forms a closed ring.

The ribs can also have a partially circumferential configuration. In one form, a partially circumferential rib does not extend over the full circumference of the internal wall and forms one or more rib segments, which can also be referred to as ring segments. In another configuration, it is provided that a plurality of rib segments are arranged at a height of the internal wall, which may be spaced apart from one another in the circumferential direction. A plurality of rib segments arranged at a height on the internal wall in the circumferential direction are to be understood as a partially circumferentially extending rib in the meaning of the present disclosure.

In another configuration, it is provided that the rib is configured to be approximately or exactly trapezoidal, rectangular, triangular, arc segment-shaped and/or at least partially oval in cross-section. In one form, the ribs each have two flanks which, in particular in the case of a triangular, trapezoidal and/or arc segment-shaped design of the ribs, are at an angle of about 60° to about 90°, in one form about 65° to about 75°, and in one form about 70° to one another. In one form, which can be addressed as rectangular, the two flanks are connected to each other via a middle portion. The two flanks are then substantially parallel to each other. The middle portion can be configured to be linear or arcuate.

In one form, the first internal wall portion has a plurality of partially circumferentially extending ribs on the inside, in one form about two to about ten, in another form about three to about four, and in one form of completely circumferentially extending ribs.

When the term “about” is used in connection with values or ranges of values, it is to be understood to mean a tolerance value which is considered customary by those skilled in the art in this field, in particular, a tolerance range of ±20%, in one form ±10%, and in another form ±5% is provided. Insofar as different value ranges are indicated in the present disclosure, the lower limits and the upper limits of the different value ranges can be combined with each other.

In another configuration, it is provided that the ribs are spaced apart from each other by a spacing in the longitudinal direction of the sealing insert, which may be by an approximately uniform spacing. In particular, a spacing of the ribs is dimensioned such that an engagement of corrugation crests of a corrugated pipe between the ribs is possible. In particular, if only one rib is provided, it can be arranged in a corrugation trough of the corrugated pipe. In this form, the rib may have a design in terms of its shape that is adapted to a corrugation trough of the corrugated pipe, in particular corresponds substantially in terms of its outer contour to the contour of the corrugation trough. In one form, the spacing of the ribs, the radial extent of the ribs into the cavity formed by the cutout, the cross-section of the ribs and/or an angle of the flanks of the ribs are adapted to the corrugation of a corrugated pipe, at least to a partial region or a partial length thereof, which can or is intended to cooperate with the sealing insert. In one form, the outer contour of the ribs corresponds substantially to a contour of the corrugation troughs of the corrugated pipe. In particular, the sealing insert is configured in such a manner that, in the case of a design with at least two ribs, an engagement in corrugation troughs of the corrugated pipe is made possible by the ribs. In another form, it is provided that the ribs have the same spacing from center to center as the corrugation troughs from center to center of the corrugated pipe that can be used with the sealing insert. In one form, the extent of the ribs in the longitudinal direction of the sealing insert is less than or equal to an extent of the corrugation troughs in the longitudinal direction of the corrugated pipe.

In another configuration, it is provided that the center-to-center spacing of two ribs adjacent in the longitudinal direction of the sealing insert is about 1 mm to about 1 cm.

In yet another configuration, it is provided that the at least partially circumferentially extending ribs are distributed over the length of the first internal wall portion, and in an alternative configuration may be over the entire length of the internal wall delimiting the cutout. In this alternative configuration, the design of the internal wall is thus identical to that of the first internal wall portion.

In another configuration, it is provided that at least one rib is flush with the first end face or the second end face. In particular, it can be provided that the rib forms part of the first end face and/or the second end face.

In yet another configuration, it is provided that the internal wall delimiting the cutout comprises a second internal wall portion. In one form, it is provided that the second internal wall portion does not comprise ribs. The second internal wall portion is not implemented if, as described above, in an alternative form, the internal wall comprises ribs over the entire length thereof. In one configuration, it is provided that the internal wall of the sealing insert comprises the first internal wall portion and the second internal wall portion, wherein the first internal wall portion comprises the ribs and wherein the second internal wall portion does not comprise ribs. In one form, it is provided that the second internal wall portion has a substantially smooth surface.

The lengths of the internal wall portions in the direction of the longitudinal axis can be selected independently of one another as desired. For example, the first internal wall portion can be shorter or longer than the second internal wall portion or as long as the second internal wall portion.

In another configuration, it is provided that the sealing insert comprises a first end face and an opposing second end face and at least one slit extending from the first end face to the second end face. The slit allows the sealing insert to be conveniently placed around the corrugated pipe, so that it is in particular not desired to push the corrugated pipe through the sealing insert against the resistance of the sealing insert and in particular the ribs.

In another configuration, it is provided that the sealing insert has two slits. This results in a two-part configuration of the sealing insert, which allows the corrugated pipe to be provided with the sealing insert quickly and conveniently. In particular, a two-part configuration of the sealing insert is provided if the material of the sealing insert is so rigid that it would either be inconvenient for the user to bend the sealing insert open or that the material could be plastically deformed and/or break when bent open to fit the sealing insert onto the corrugated pipe.

In yet another configuration, it is provided that the sealing insert does not have a slit.

In one configuration, it is provided that the first external wall portion is associated with the first end face of the sealing insert. In particular, the first external wall portion is an outer shell surface portion of the sealing insert having the first outer diameter. In one form, the first external wall portion is adjacent to the first end face. The second external wall portion is in particular an outer shell surface portion of the sealing insert having the second outer diameter. The second external wall portion may be adjacent the second end face. The lengths of the external wall portions in the direction of the longitudinal axis can be selected independently of each other as desired. For example, the first external wall portion can be shorter or longer than the second external wall portion or as long as the second external wall portion.

The lengths of the external wall portions and the internal wall portions in the direction of the longitudinal axis can be arbitrarily selected independently of each other as desired. For example, the first external wall portion can be shorter or longer than the first internal wall portion or as long as the first internal wall portion and/or can be shorter or longer than the second internal wall portion or as long as the second internal wall portion, and/or for example, the second external wall portion can be shorter or longer than the first internal wall portion or as long as the first internal wall portion and/or can be shorter or longer than the second internal wall portion or as long as the second internal wall portion.

In one configuration, it is provided that a material thickness of the sealing insert decreases towards the first end face and/or towards the second end face. In particular, the change in material thickness is continuous. In another configuration, it is provided that the change in the material thickness of the sealing insert is discrete, that is, in steps or stages.

In another configuration, it is provided that the change in the material thickness of the sealing insert is configured to reduce the outer diameter of the sealing insert towards the first end face. In another configuration, it is provided that the reduction of the material thickness of the sealing insert is implemented by an inner diameter of the cutout of the sealing insert increasing towards the first end face, wherein the outer diameter of the sealing insert can substantially remain the same or can increase discretely, in particular by providing a step. In particular, in one form the second internal wall portion of the internal wall of the cutout is conically shaped, while in another form the first and optionally also the second external wall portion remains substantially cylindrical. In one form, it is provided that a taper of the second internal wall portion narrows towards the first internal wall portion.

In another configuration, it is provided that the material thickness of the sealing insert becomes smaller, thus decreases, towards the first or the second end face only in the region of the second internal wall portion, depending on the configuration.

For example, the first external wall portion and a second internal wall portion are each arranged adjacent to the first end face. According to the present disclosure, the outer diameter of the second external wall portion is smaller than that of the first external wall portion. The first internal wall portion and the second external wall portion are arranged adjacent to the second end face. According to the present disclosure, the first external wall portion and the second external wall portion are each formed cylindrically. The first internal wall portion is formed substantially cylindrically and has inwardly projecting ribs. In this form, the second internal wall portion is formed conically and has an inner diameter that increases towards the first end face.

In another configuration, it is provided that the material thickness of the sealing insert in the region of the second internal wall portion is substantially constant over the length thereof in the longitudinal direction of the sealing insert. Moreover, this sealing insert can be formed as in the configuration described above.

In particular, in another configuration, it is provided that the material thickness of the sealing insert in at least one partial portion of the second internal wall portion becomes smaller towards the first end face of the sealing insert, thus decreases.

In another configuration, an outer circumferentially extending shoulder, which can also be addressed as a step, is formed between the first external wall portion and the second external wall portion. In one form, a discrete transition in the form of a step or shoulder is provided from the first outer diameter to the second outer diameter. In another configuration, a continuous transition is provided from the first external wall portion having the first outer diameter to the second external wall portion having the second outer diameter, wherein in one form at least one segment of the external wall is formed conically towards the second end face of the sealing insert. In another form, it is provided that the material thickness of the sealing insert is configured to be constant towards the second end face.

In another configuration, the sealing insert comprises an anti-rotation structure. According to the present disclosure, it is provided that an anti-rotation structure is arranged on an outer shell of the sealing insert.

In another configuration, it is provided that the anti-rotation structure comprises a plurality of latching elements arranged parallel to the longitudinal direction of the sealing insert. The latching elements can be configured, for example, as grooves and/or as ribs. In particular, the grooves can be longitudinally extending notches or cutouts. The ribs are in particular longitudinally extending projections protruding radially outwardly. According to the present disclosure, the anti-rotation structure is associated with the second external wall portion. In one form, the anti-rotation structure is arranged on the second external wall portion, adjacent to the first external wall portion. In another configuration, it is provided that the latching elements arranged parallel to a longitudinal axis extend from the first external wall portion to adjacent the second end face over the second external wall portion and thus over the entire length of the second external wall portion.

In another configuration, it is provided that the anti-rotation structure is arranged on the second external wall portion, spaced apart from the second end face. In particular, between the anti-rotation structure and the second end face, the second external wall portion is formed with a smooth or flat surface.

In another configuration, it is provided that the anti-rotation structure is arranged on the second external wall portion, spaced apart from the first external wall portion. In particular, between the anti-rotation structure and the first external wall portion, the surface of the second external wall portion is formed to be smooth or flat. In this configuration, the anti-rotation structure can extend to adjacent the second end face of the sealing insert.

In another configuration, it is provided that the anti-rotation element may be arranged extending completely circumferentially on the outer shell. In particular, the latching elements are uniformly distributed on the circumference of the second external wall portion. The latching elements of the anti-rotation structure can be shaped in cross-section like the ribs on the internal wall of the sealing insert, as described above.

In one configuration, it is provided that the sealing insert comprises a material that may be elastically deformable, selected from a group comprising silicone, thermoplastic elastomers, and/or rubber.

In another configuration, the sealing insert comprises a first end face and a second end face. The exemplary sealing insert is substantially cylindrically shaped and has a cutout passing completely therethrough. An outer shell of the sealing insert comprises the first and the second external wall portion, wherein the first external wall portion is adjacent to the first end face and the second external wall portion is adjacent to the second end face. The second external wall portion comprises, for example, an anti-rotation structure configured as a plurality of axially parallel latching elements distributed on the circumference of the second external wall portion. As an example, the anti-rotation structure is adjacent to the first external wall portion and protrudes to approximately the middle of the second external wall portion. As an example, the latching elements each have two flanks which are at a flank angle of approximately 70° to one another or are formed approximately parallel to one another, wherein these flanks then are connected by a middle part, as described above in connection with the design of the ribs on the internal wall as seen in cross-section.

The exemplary sealing insert includes a slit completely passing through from the first end face to the second end face. By way of the slit, the sealing insert can be bent open and attached onto a corrugated pipe. In another exemplary configuration, the sealing insert is configured in two parts, wherein the sealing insert has two slits passing completely through from the first end face to the second end face.

The completely through-passing cutout includes a first internal wall portion and a second internal wall portion. The second internal wall portion has a smooth surface. It also has a conical configuration. In particular, the internal wall tapers in the second internal wall portion toward the first internal wall portion or, respectively, the internal wall widens toward the first end face of the sealing insert. The inner diameter of the second internal wall portion increases towards the first end face of the sealing insert. The second internal wall portion has a second material thickness that tapers or decreases at least in certain sections towards the first end face, thereby making the cutout in the second internal wall portion conical.

As an example, the first internal wall portion comprises four ribs extending circumferentially on the internal wall of the cutout. The first internal wall portion is adjacent to the second end face. In an alternative exemplary configuration, the ribs are substantially uniformly distributed over a full height of the internal wall. In this configuration, the sealing insert has only a first internal wall portion. At least one rib can be flush with the end face, such as the first end face and/or the second end face.

On the outer shell, the exemplary sealing insert comprises the first and the second external wall portions. The first external wall portion has a first outer diameter that is larger than the second outer diameter of the second external wall portion. This forms a shoulder which inhibits the sealing insert from being pushed too far through a screw fastening body which, for example, is a double nipple or else another, in particular plug-like, component with a thread arranged on at least one side for arranging a pressing screw.

In another form, it is provided that the sealing insert comprises a first internal wall portion of the cutout and a second internal wall portion of the cutout. In this form, the first internal wall portion having the internally circumferentially extending ribs is adjacent to the first end face, wherein in particular the internally circumferentially extending rib is flush with the first end face. Thus, the first internal wall portion of the cutout is arranged approximately in the region of the first external wall portion. Furthermore, the second internal wall portion of the cutout is arranged approximately in the region of the second external wall portion.

Furthermore, a corrugated-pipe screw fastening system is disclosed, comprising at least one pressing screw, a screw fastening body and a sealing insert as described above.

The screw fastening body is in particular configured as a double nipple, but can also be configured otherwise, for example as a plug housing or component with a thread arranged on at least one side for arranging the pressing screw. In one form, the screw fastening body has a first external thread, and in another form a second external thread. In one form, the screw fastening body comprises a key support structure having at least one key support surface between the first external thread and the second external thread. In one configuration, the key support structure comprises a stop surface for the pressing screw. If the screw fastening body is not formed as a double nipple and, in particular, does not have a key support structure, it can nevertheless have a stop surface which is provided, for example, by a component or plug housing of the screw fastening body arranged opposite the thread. If the pressing screw is screwed onto the screw fastening body, it can in particular be screwed on to such an extent that it is screwed down to the stop surface and thus locks with the screw fastening body. In particular, the pressing screw can be screwed onto the screw fastening body until it abuts against a block provided by the stop surface. This has the advantage that the pressing screw cannot simply unscrew itself from the screw fastening body, for example due to temperature fluctuations or vibrations. In particular, the pressing screw is configured as a coupling nut with a central through-cutout. In particular, the pressing screw has a pressing contour on the internal wall of the cutout, by way of which the sealing insert inserted at least partially into the screw fastening body can be deformed when the pressing screw is being screwed onto the screw fastening body.

In one configuration, it is provided that the screw fastening body comprises an anti-rotation structure that corresponds to the anti-rotation structure of the sealing insert. In particular, it is provided that the sealing insert comprises a rib, in one form a plurality of ribs, on the second external wall portion and the screw fastening body comprises a groove, in one form a plurality of grooves, in which the ribs of the sealing insert can engage. In a further configuration, it is provided that the screw fastening body has a rib, in one form a plurality of ribs, on the inner surface of the through-passing cutout, which ribs engage in grooves of the anti-rotation structure of the sealing insert. In another configuration, it is provided that both the sealing insert on the second external wall portion and the screw fastening body on the inner surface have a rib, in one form a plurality of ribs, which may engage each other in each case in a mutually offset manner.

In one configuration, a corrugated-pipe screw fastening system comprises a pressing screw and a screw fastening body on which the pressing screw can be screwed. The sealing insert is placed in the screw fastening body, in particular in the region of the at least one external thread of the screw fastening body. An O-ring, arranged for example in an annular groove in a key support structure or in a region of a support surface on the screw fastening body, can seal the latter against a connection geometry which is only formed, for example, as a fuse box, machine part, etc. The screw fastening body has an anti-rotation structure on the inside which corresponds to the anti-rotation structure of the sealing insert. The individual parallel latching elements of the anti-rotation structure of the sealing insert engage in the regions between the parallel latching elements of the anti-rotation structure of the screw fastening body.

In one configuration, an inner diameter of the screw fastening body in a region where the sealing insert is inserted is smaller than the first outer diameter of the sealing insert. In one form, the first outer diameter is larger than a core diameter of the screw fastening body. The core diameter is the smallest inner diameter of the screw fastening body in the insertion region of the sealing insert in the region of the at least one external thread of the screw fastening body, which is in particular due to the parallel latching elements. In one form, the first outer diameter of the sealing insert is smaller than or approximately equal to an outer diameter of the at least one external thread of the screw fastening body. Thus, the sealing insert is only partially inserted into the screw fastening body so that the first external wall portion is seated on the screw fastening body, in particular supported by a shoulder of the sealing insert. In one form, the sealing insert may protrude with the first external wall portion from the screw fastening body. In one form, the sealing insert protrudes into the screw fastening body with the first external wall portion and/or the second external wall portion, in particular when the second external wall portion has a smaller outer diameter than the first external wall portion of the sealing insert. When the pressing screw is screwed onto the screw fastening body, it presses against the sealing insert.

The pressing screw has an internal, circumferential pressing contour that presses against the first external wall portion of the sealing insert when the pressing screw is screwed onto the screw fastening body. Advantageously, independent of a corrugated pipe inserted into the corrugated-pipe screw fastening system, in particular within certain dimensional tolerances of a diameter of the corrugated pipe, the pressing screw can be screwed with a circumferential end face of the pressing screw up to a stop surface of the screw fastening body, which stop surface is provided, for example, by a key support structure or a component of the screw fastening body. Such a screw fastening has the advantage that accidental loosening, for example due to temperature fluctuations or vibrations, is reduced, since in this case the thread geometries of the pressing screw and the screw fastening body are braced against each other. In a conical configuration of the second internal wall portion of the cutout of the sealing body, the material of the sealing body can be displaced up to the corrugated pipe, in particular radially inwards, without damaging the corrugated pipe. This is a particularly advantageous configuration if the material of the sealing insert is very strong or rigid, or if the sealing insert has a large volume, since with a conical design of the second internal wall portion, the forces to be applied for a screw fastening against block are reduced.

In another configuration, the corrugated-pipe fastening system comprises a sealing insert that is configured in two parts. Two slits are made for the two-piece configuration of the sealing insert.

Furthermore, the present disclosure discloses is a use of a sealing insert, as described above, in a corrugated-pipe screw fastening system, as described above, for sealing a corrugated pipe against the corrugated-pipe screw fastening system and for inhibiting the sealing insert and/or the corrugated pipe from rotating in a screw fastening body.

Furthermore, a use of a corrugated-pipe screw fastening system as described above is disclosed for connecting a corrugated pipe to a connection geometry. The corrugated pipe can also be further passed through the interior of the corrugated-pipe screw fastening system such that it protrudes on both sides thereof. Advantageously, the corrugated pipe is inserted into the sealing insert in such a manner that, in the fitted state, it protrudes beyond the corrugated-pipe screw fastening system on the pressing screw side and on the screw fastening body side. The fitted state is defined by the corrugated pipe being embraced by the corrugated-pipe screw fastening system and sealingly received by tightening the pressing screw thereof.

Furthermore, a method for fitting a corrugated pipe having a plurality of corrugation troughs to a fitting geometry is disclosed. The method comprises the steps threading a pressing screw onto the corrugated pipe; inserting the corrugated pipe in the cutout of a sealing insert in such a manner that at least one rib, in one form a plurality of ribs, in one form at least two ribs, are in engagement with one corrugation trough, if at least two ribs are provided, are in engagement with two corrugation troughs, generally, if there is a predetermined number of ribs, these ribs are in engagement with a number of corrugation troughs of the corrugated pipe corresponding to this number of ribs; inserting a screw fastening body into the connection geometry; inserting the sealing insert with the corrugated pipe into the screw fastening body, wherein the anti-rotation structure of the sealing insert is brought in engagement with an anti-rotation structure of the screw fastening body and the sealing insert with the first external wall portion protrudes from the screw fastening body; and screwing the pressing screw onto the screw fastening body in such a manner that a material displacement of a material of the sealing insert is created by the pressing screw, wherein the material rests at least partially sealingly against the corrugated pipe.

The connection geometry is a component to which the corrugated pipe can be connected by the corrugated- pipe screw fastening system. In particular, at least one elongated part, for example at least one cable, which runs through the corrugated pipe, can be fed through the connection geometry.

By way of example, the connection geometry is a wall, a housing, a machine part, a plug for making an electrical connection or a cable guide. Advantageously, the corrugated-pipe screw fastening system is attached to the connection geometry. In one form, the connection geometry has a through-cutout through which the at least one elongated part can be fed. In one form, the corrugated-pipe screw fastening system is attached to the connection geometry such that the longitudinal axis of the connection part is substantially perpendicular to a surface of the connection geometry and/or extends through the through-cutout. In one form, the through-cutout has a thread into which, advantageously, the screw fastening body can be screwed with its external thread. In another form, the through-cutout does not have a thread and is configured in particular as a bore. The screw fastening body can be inserted through the through-cutout and, for example, if it has an external thread there, can be screwed by a nut on the opposite side of the connection geometry. However, other fastening methods are also possible, depending on the design of the screw fastening body. Advantageously, the corrugated pipe can be inserted into the sealing insert in such a manner that, in the fitted state, it projects beyond the corrugated-pipe screw fastening system on the pressing screw side and on the screw fastening body side.

In one form, the sealing insert is inserted into the screw fastening body in such a manner that the first external wall portion is seated on the screw fastening body. In one configuration, it is provided that by screwing the pressing screw onto the screw fastening body, the sealing insert arranged in and protruding beyond the screw fastening body is deformed by a pressing contour of the pressing screw on its inner side in such a manner that the material of the sealing insert is displaced, in particular radially inwards, although a displacement of the material in other directions can also take place. Because of this and in particular because of the additional sealing provided by the ribs of the sealing insert, which fit into the corrugation troughs of the corrugated pipe, a particularly high degree of tightness is created.

According to the present disclosure, it is provided that an anti-rotation structure of the sealing insert is brought into engagement with an anti-rotation structure of the screw fastening body, in particular to reliably inhibit rotation of the sealing insert in the screw fastening body. In one form, a latching element of the second external wall portion of the sealing insert, in one form a plurality of latching elements of the second external wall portion of the sealing insert, is brought into engagement with a latching element of the screw fastening body, in one form with a plurality of latching elements of the screw fastening body. In one form, a latching element of the anti-rotation structure of the sealing insert, in one form a plurality of latching elements of the anti-rotation structure of the sealing insert, is brought into engagement with a latching element of the screw fastening body, in one form with a plurality of latching elements of the screw fastening body.

In a further configuration, it is provided that the pressing screw is screwed onto a stop surface of the screw fastening body.

This screw fastening against block, i.e. the screw fastening of the pressing screw onto the stop surface of the screw fastening body, can be achieved in particular in that the internal wall of the sealing insert delimiting the cutout is configured to be conical, in particular in the first internal wall portion or the second internal wall portion facing the pressing screw. The advantage of the screw fastening against block is that through this, a uniform force is exerted on the corrugated pipe and, in particular, that excessive, especially punctual pressure by the screw fastening or by the sealing insert on the corrugated pipe, which could damage the corrugated pipe, can be avoided. In this manner, a good sealing effect is achieved.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a sealing insert according to the principles of the present disclosure;

FIG. 2 is an end view of the sealing insert of FIG. 1;

FIG. 3 is a cross-sectional view of the sealing insert of FIG. 1 taken along line III-III of FIG. 2;

FIG. 4 is a perspective view of an alternative sealing insert according to the principles of the present disclosure;

FIG. 5 is a top view of a second end face of the sealing insert of FIG. 4;

FIG. 6 is a cross-sectional view of the sealing insert of FIG. 4 taken along line VI-VI of FIG. 5;

FIG. 7 is an exploded view of a corrugated-pipe screw fastening system according to the principles of the present disclosure;

FIG. 8 is an end view of a pressing screw of the fitted corrugated-pipe screw fastening system of FIG. 7;

FIG. 9 is a partial cross-sectional view of the fitted corrugated-pipe screw fastening system of FIG. 7 taken along line IX-IX of FIG. 8; and

FIG. 10 is another corrugated-pipe screw fastening system according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

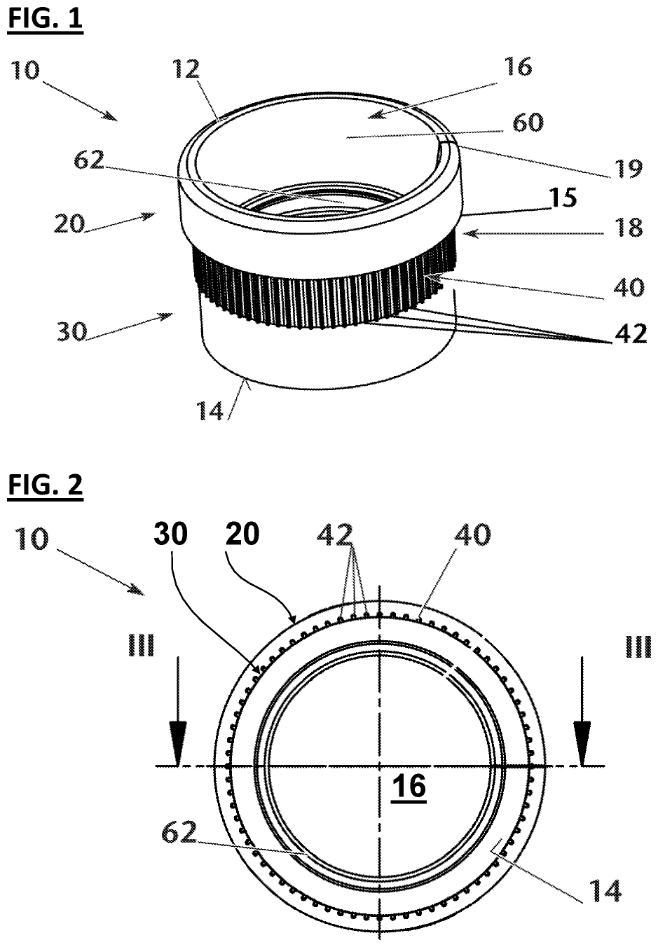

FIG. 1 shows a sealing insert 10 having a first end face 12 and a second end face 14. The sealing insert 10 is substantially cylindrical in shape and has a cutout 16 passing completely therethrough. An outer shell 18 of the sealing insert 10 comprises a first external wall portion 20 and a second external wall portion 30, wherein the first external wall portion 20 is adjacent to the first end face 12 and the second external wall portion 30 is adjacent to the second end face 14. An outer diameter of the first external wall portion 20 is larger than that of the second external wall portion 30, the latter being discretely adjacent to each other by a step 15.

The second external wall portion 30 includes an anti-rotation structure 40 configured as a multiplicity of axially parallel latching elements 42 distributed on the circumference of the second external wall portion 30, not all of which are denoted by reference signs for clarity. The anti-rotation structure 40 is adjacent to the first external wall portion 20 and, in this form, protrudes in its longitudinal extent to approximately the middle of the second external wall portion 30.

The sealing insert 10 comprises a slit 19 passing completely through from the first end face 12 to the second end face 14. By way of the slit, the sealing insert 10 can be bent open and attached onto a corrugated pipe not shown here.

FIG. 1 further shows that the sealing insert 10 has at least one circumferential rib 62 on an internal wall 60 of the cutout 16.

FIG. 2 shows a top view of the second end face 14 of the sealing insert 10 of FIG. 1. The anti-rotation structure 40 has a plurality of axially parallel latching elements 42, which are in particular uniformly arranged on an outer circumference of the second external wall portion 30. This view also shows a rib 62 arranged in the cutout 16 passing completely through the sealing insert 10.

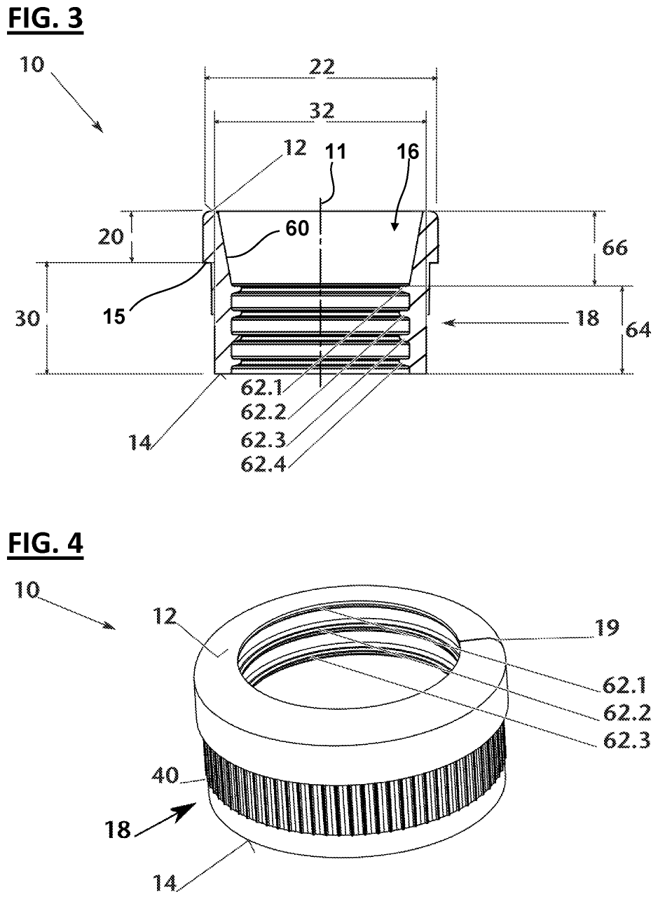

FIG. 3 shows a sectional view taken along line III-III of FIG. 2. The cutout 16 passing completely therethrough in the direction of a longitudinal axis 11 comprises the internal wall 60 forming a first internal wall portion 64 and a second internal wall portion 66. The second internal wall portion 66 has a conical configuration. It is adjacent to the first end face 12 and is associated with the first external wall portion 20. In particular, the internal wall 60 narrows in the second internal wall portion 66 towards the first internal wall portion 64 or, respectively, the internal wall 60 widens towards the first end face 12. An internal cross-section of the internal wall 60 in the second internal wall portion 66 thus enlarges towards the first end face 12 of the sealing insert 10. The second internal wall portion has a material thickness that decreases towards the first end face 12. The cutout 16 is designed to be conical in the second internal wall portion 66.

The first internal wall portion 64 comprises four ribs 62.1 to 62.4 circumferentially extending in the circumferential direction, wherein the rib 62.1 corresponds to the rib 62 which is the only one clearly visible in FIG. 1. The first internal wall portion 64 is adjacent to the second end face 14. The first internal wall portion is associated with the second external wall portion 30.

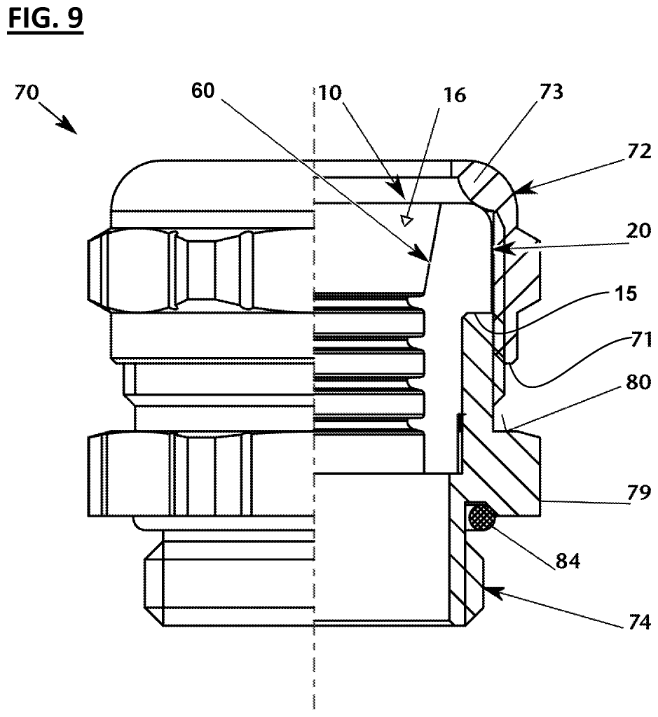

The outer shell 18 of the sealing insert 10 comprises the first external wall portion 20 and the second external wall portion 30. The first external wall portion 20 has a first outer diameter 22 which is larger than a second outer diameter 32 of the second external wall portion 30. As a result of this, a step 15 is formed which, as can be seen for example in FIG. 9, inhibits an insertion too far into a screw fastening body 74 shown in FIG. 9, which is formed as a double nipple.

The lengths of the external wall portions 20, 30 and of the internal wall portions 64, 66 in the direction of the longitudinal axis 11 are selected such that the first external wall portion 20 is shorter than the second internal wall portion 66, the second internal wall portion 66 is shorter than the first internal wall portion 64, and the first internal wall portion 64 is shorter than the second external wall portion 30. However, independently from each other, these lengths can be selected differently as desired.

FIG. 4 shows an alternative configuration of a sealing insert 10. The sealing insert 10 has a slit 19 that allows to bend the sealing insert 10 open in order to secure it to a corrugated tube that is not shown. The sealing insert 10 has a first end face 12 and a second end face 14. Furthermore, the sealing insert 10 has inner circumferentially extending ribs 62.1, 62.2, and 62.3. The circumferential rib 62.1 is flush with the first end face 12. In particular, a flank of the rib 62.1 at least partially forms the first end face 12. An anti-rotation structure 40 is arranged on the outer shell 18.

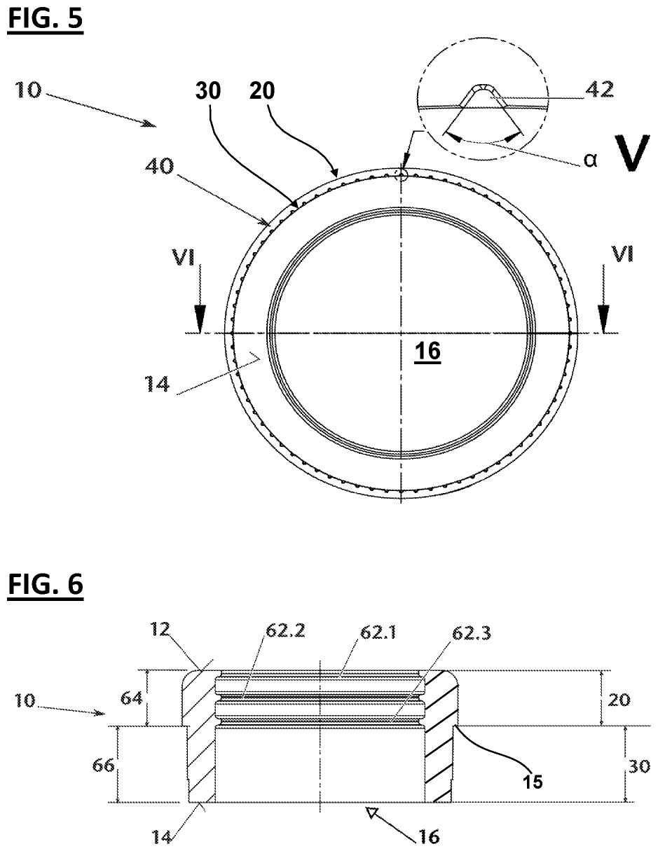

FIG. 5 shows a view on the second end face 14 of the sealing insert 10 of FIG. 4. In detailed view V, it can be seen that the anti-rotation structure 40 has axially parallel latching elements 42 which have a flank angle a of about 70°.

FIG. 6 shows the sectional view taken along line VI-VI of FIG. 5. The sealing insert 10 comprises a first internal wall portion 64 of the cutout 16 and a second internal wall portion 66 of the internal wall of the cutout 16. The first internal wall portion 64 having the inner circumferentially extending ribs 62.1 to 62.3, is adjacent to the first end face 12, with the inner circumferentially extending rib 62.1 being flush with the first end face 12. The first internal wall portion 64 of the cutout 16 is associated with a first external wall portion 20 adjacent to the first end face 12. The second internal wall portion 66 of the cutout 16 is associated with a second external wall portion 30 adjacent to the second end face 14. A step 15 is formed between the first external wall portion 64, which has a larger outer diameter than the second external wall portion 66, as in the configurations according to FIGS. 1 to 3.

The lengths of the external wall portions 20, 30 and of the internal wall portions 64, 66 in the direction of the longitudinal axis 11 are selected such that the first external wall portion 20 is as long as the first internal wall portion 64 and shorter than the second internal wall portion 66, and the second internal wall portion 66 is as long as the second external wall portion 30. However, independently from each other, these lengths can be selected differently as desired.

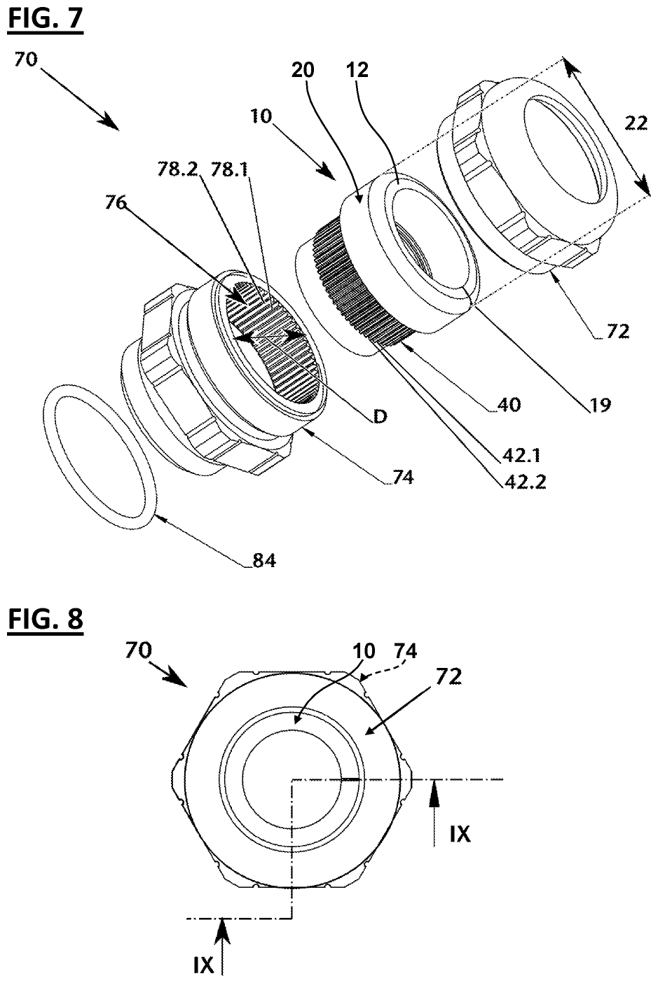

FIG. 7 shows a corrugated-pipe screw fastening system 70 having a pressing screw 72 and a screw fastening body 74 onto which the pressing screw 72 can be screwed. A sealing insert 10, formed similarly to the sealing insert 10 according to FIGS. 1 to 3 and having a slit 19 is placed in the screw fastening body 74. An O-ring 84, which is arranged on the screw fastening body 74 formed as a double nipple, seals the latter against a connection geometry which is not shown. The screw fastening body 74 has an inner anti-rotation structure 76 corresponding to an anti-rotation structure 40 of the sealing insert 10. The individual axially parallel latching elements, designated by 42.1 and 42.2 as an example, of the anti-rotation structure 40 of the sealing insert 10 engage in the gaps between the axially parallel latching elements, designated by 78.1 and 78.2 as an example, of the anti-rotation structure 76 of the screw fastening body 74.

In particular, an inner diameter D of the screw fastening body 74 is smaller than a first outer diameter 22 of the sealing insert 10. The sealing insert 10 is thus only partially insertable into the screw fastening body 74 so that a first external wall portion 20 and a first end face 12 of the sealing insert 10 protrude beyond the screw fastening body 74. When the pressing screw 72 is screwed onto the screw fastening body 74, it presses on the sealing insert 10 and causes a displacement of material there, in particular in the region of the first external wall portion 20, for sealing against the corrugated pipe which can be fed through the sealing insert 10.

FIG. 8 shows the corrugated-pipe screw fastening system 70 of FIG. 7 in a top view of the pressing screw 72.

FIG. 9 shows the sectional view taken along line IX-IX from FIG. 8. The pressing screw 72 has an internal circumferential pressing contour 73 that presses on the first external wall portion 20 and the first end face 12 of the sealing insert 10 when the pressing screw 72 is screwed onto the screw fastening body 74. The pressing screw 72, independent of the corrugated pipe, which is not shown here, in particular within certain dimensional tolerances of a diameter of the corrugated pipe, has a circumferential end face 71 so that the pressing screw 72 can be screwed on until the end face 71 of the pressing screw 72 comes into contact with a stop surface 80 of the screw fastening body 74. In this form, the stop surface 80 is formed by a key support structure 79 formed on the screw fastening body 74. Such a screw fastening is called a screw fastening against block and has the advantage that an accidental loosening, for example due to temperature fluctuations or vibrations, does not occur so quickly, since in this case the thread geometries of the pressing screw 72 and the screw fastening body 74, which are not described in more detail, are braced against each other. Due to the conical configuration of an internal wall 60 in an upper internal wall portion, corresponding to the second internal wall portion 66 of the configuration according to FIGS. 1 to 3, of the cutout 16 of the sealing insert 10, the material of the sealing body 10 can be moved up to the corrugated pipe, which is not shown here, without the corrugated pipe being damaged and, respectively, a uniform contact pressure of the sealing element on the corrugated pipe is achieved. The sealing insert 10 is deformed under the pressure of the pressing screw 72 and, with regard to its material and its dimensions, can advantageously be formed in such a manner that a screw fastening against block is made possible. The O-ring 84 is arranged in an annular groove, which is not described further, below the key contact structure 79 of the screw fastening body 74.

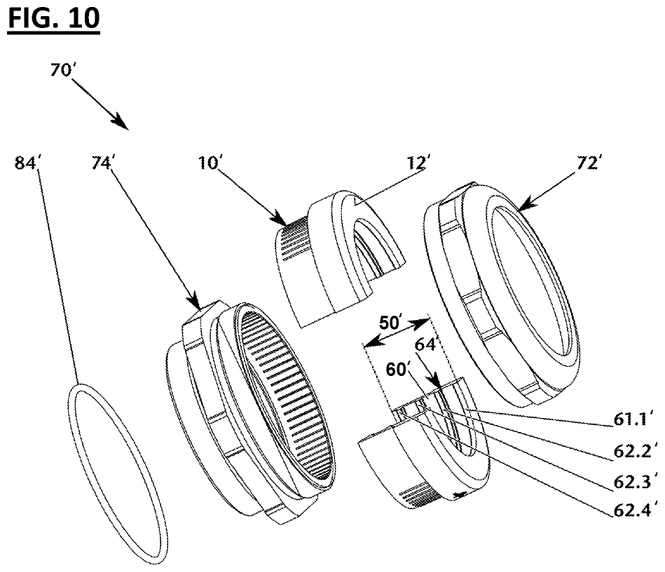

FIG. 10 shows another alternative configuration of the corrugated-pipe screw fastening system 70′. It comprises a pressing screw 72′ that is screwable onto a screw fastening body 74′ formed as a double nipple, and a sealing insert 10′ that is configured in two parts but otherwise configured similar to the sealing insert 10 shown in FIGS. 4 to 6. Two slits are made for the two-piece configuration of the sealing insert 10′, which are not described further here. Furthermore, the corrugated-pipe screw fastening system 70′ has an O-ring 84′ attached onto the screw fastening body 74′.

The sealing insert 10′ has four inner circumferentially extending ribs 61.1′ to 61.4′ distributed substantially uniformly over the full length 50′ of an internal wall 60′, which is a significant difference of the sealing insert 10′ of this form from that of FIGS. 4 to 6. Thus, the sealing insert 10′ has only a first internal wall portion 64′. It can also be seen from the configuration shown that the circumferential rib 61.1′ is flush with a first end face 12′ of the sealing insert 10′.

The corrugated-pipe screw fastening system and the sealing insert inserted therein differ from the fittings for corrugated pipes previously known from the prior art. In particular, the corrugated-pipe screw fastening system makes it possible to achieve a very high degree of tightness while at the same time taking up very little installation space. The corrugated-pipe screw fastening system also makes it possible to provide a direct connection to a connection geometry, for example a housing wall or a connector system, without the need for further components, as would be desired with fittings, for example. A corrugated pipe can also be fed further inside the corrugated pipe screw fastening system such that it protrudes beyond both sides thereof. This simplifies the fitting process considerably; in particular, there is no need to dimension or precisely cut the corrugated pipe to length before fitting it with the corrugated-pipe screw fastening system according to the present disclosure, since this can be done subsequently to the fitting of the corrugated-pipe screw fastening system, if desired. Moreover, the sealing effect is improved compared to known corrugated-pipe fastening systems, in which a corrugated pipe end is received in a system component and thus the corrugated pipe ends in the known system, since the end of the corrugated pipe with its often unclean cutting edge as well as the position in the system component does not exert any influence on the sealing effect in the corrugated-pipe screw fastening system according to the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A sealing insert for a corrugated-pipe screw fastening system, the sealing insert comprising:
a cutout for receiving a corrugated pipe;
first and second end faces;
a first external wall portion having a first outer diameter; and
a second external wall portion having a second outer diameter;
wherein:
an internal wall delimiting the cutout comprises at least one circumferential rib that extends in a circumferential direction of the longitudinal axis about at least a portion of a circumference of the inner wall;
the first external wall portion is adjacent to the first end face and extends along a longitudinal axis of the sealing insert up to the second external wall portion;
the second external wall portion is adjacent to the second end face and extends along the longitudinal axis up to the first external wall portion;
the first outer diameter is larger than the second outer diameter;
the first and second external wall portions are each configured to be cylindrical;
an anti-rotation structure is arranged on an outer shell of the sealing insert; and
the anti-rotation structure is associated with the second external wall portion.

2. The sealing insert according to claim 1, wherein the at least one circumferential rib comprises at least two circumferential ribs.

3. The sealing insert according to claim 2, wherein the at least two circumferential ribs are uniformly spaced apart from one another.

4. The sealing insert according to claim 1, wherein the at least one circumferential rib is trapezoidal, rectangular, triangular, arc segment-shaped or at least partially oval in cross-section.

5. The sealing insert according to claim 1, wherein:
the internal wall comprises a first internal wall portion and a second internal wall portion, the first internal wall portion comprises the at least one circumferential rib, the second internal wall portion does not comprise a rib.

6. The sealing insert according to claim 5, wherein the first internal wall portion is associated with the first end face or the second end face.

7. The sealing insert according to claim 1, wherein at least one circumferential rib is flush with the first end face or the second end face.

8. The sealing insert according to claim 1, wherein at least one slit passes through from the first end face to the second end face.

9. The sealing insert according to claim 1, wherein a material thickness of the sealing insert decreases towards the first end face and/or towards the second end face.

10. The sealing insert according to claim 1, wherein:
the internal wall comprises a first internal wall portion and a second internal wall portion,
the first internal wall portion comprises the at least one circumferential rib,
the second internal wall portion does not comprise a rib, and
the material thickness of the sealing insert decreases only in the second internal wall portion towards the first or the second end face.

11. The sealing insert according to claim 1, wherein the anti-rotation structure comprises a plurality of latching elements arranged parallel to the longitudinal axis of the sealing insert.

12. A corrugated-pipe screw fastening system comprising:
a pressing screw;
a screw fastening body; and
the sealing insert according to claim 1.

13. The corrugated-pipe screw fastening system according to claim 12, wherein the screw fastening body comprises an anti-rotation structure corresponding to the anti-rotation structure of the sealing insert.

14. The corrugated-pipe screw fastening system according to claim 12, wherein the screw fastening body comprises a stop surface for the pressing screw.

15. A method for fitting a corrugated pipe having a plurality of corrugation troughs to a connection geometry, the method comprising the steps of:
threading a pressing screw onto the corrugated pipe;
inserting the corrugated pipe into the cutout of the sealing insert of claim 1 in such a manner that at least one circumferential rib is in engagement with a corresponding corrugation trough of the corrugated pipe;
inserting a screw fastening body into the connection geometry;
inserting the sealing insert with the corrugated pipe into the screw fastening body, wherein the anti-rotation structure of the sealing insert is brought into engagement with an anti-rotation structure of the screw fastening body and the sealing insert protrudes with the first external wall portion from the screw fastening body; and
screwing the pressing screw onto the screw fastening body in such a manner that a material displacement of a material of the sealing insert is created by the pressing screw, wherein the material rests at least partially sealingly against the corrugated pipe.

16. The method according to claim 15, wherein the pressing screw is screwed on up to a stop surface of the screw fastening body.

17. The method according to claim 15, wherein the corrugated pipe is inserted into the sealing insert in such a manner that it protrudes beyond the corrugated-pipe screw fastening system on a side of the pressing screw and on a side of the screw fastening body in a fitted state.
